(19) United States
(12) Patent Application Publication
(10) Pub. No.: US 2014/0295229 A1
(43) Pub. Date: Oct. 2, 2014

(54) END CAP ASSEMBLY FOR AN ELECTROCHEMICAL CELL

(71) Applicant: THE GILLETTE COMPANY, Boston, MA (US)

(72) Inventors: Jaroslav Janik, Southbury, CT (US); Thomas Lee Lindsay, Bridgeport, CT (US); Ilya Nizker, Peachtree City, GA (US); Oleg Podoprigora, New Milford, CT (US)

(73) Assignee: The Gillette Company, Boston, MA (US)

(21) Appl. No.: 13/853,109

(22) Filed: Mar. 29, 2013

(51) Int. Cl. H01M 2/04; H01M 2/12

(52) U.S. Cl. CPC H01M 2/0417; H01M 2/1241
USPC 429/89; 429/180; 429/90

(57) ABSTRACT

An end cap assembly for an electrochemical cell having an end cap, a current collector, and a seal. The end cap has a top surface and a bottom surface. The current collector has a columnar body with a head at one end thereof. The seal has a central boss with an opening through which the current collector is inserted. The seal also has a peripheral edge and a connecting part connecting the central boss with the peripheral edge. The connecting part of the seal has a top surface and a bottom surface. The central boss has a top surface and a bottom surface. The top surface of the central boss faces the bottom surface of the end cap and the bottom surface of the central boss does not extend below the bottom surface of the connecting part. The current collector is positioned within the opening of the central boss so that the head of the current collector does not touch the top surface of the central boss thus forming a gap from about 0.01 mm to about 0.50 mm between the head of the current collector and the top surface of the central boss. The head of the current collector is electrically connected to the bottom surface of the end cap.

### FIELD OF THE INVENTION

The invention relates to an alkaline electrochemical cell.

### BACKGROUND OF THE INVENTION

Electrochemical cells, or batteries, are commonly used as electrical energy sources. A battery contains a negative electrode, typically called the anode, and a positive electrode, typically called the cathode. The anode contains an active material that can be oxidized. The cathode contains an active material that can be reduced. The anode active material is capable of reducing the cathode active material. A separator is disposed between the anode and cathode. These components are disposed in a can, or housing, that is typically made from metal.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the anode and cathode to maintain charge balance throughout the battery during discharge.

There is a growing need to make batteries better suitable to power contemporary electronic devices such as toys; remote controls; audio devices; flashlights; digital cameras and peripheral photography equipment; electronic games; toothbrushes; radios; and clocks. To meet this need, batteries may include higher loading of anode and cathode active materials to provide increased service life. Batteries, however, also come in common sizes, such as the AA, AAA, AAAA, C, and D battery sizes, that have fixed external dimensions. To further enable the inclusion of increased loading of anode and cathode active materials, the internal volume of the battery housing may be increased. The reduction in the volume occupied by the end cap assembly is one available variable to provide greater internal volume within which to include additional amounts of anode and cathode active materials. These changes must, at a minimum, maintain electrolyte leakage resistance at levels comparable to current designs. There exists a need to provide an end cap assembly for use in a battery to enable an increase in internal battery volume for increasing the amount of active anode and cathode materials, while maintaining, at a minimum, electrolyte leakage resistance in order to substantially increase overall battery performance, such as power capability, service life, resistance to leakage under ambient and accelerated environmental conditions, and long-term storage.

### SUMMARY OF THE INVENTION

In one embodiment, the invention is directed towards an end cap assembly for an electrochemical cell. The end cap assembly comprises an end cap having a top surface and a bottom surface; a current collector comprising a columnar body with a head at one end thereof; and a seal comprising a central boss with an opening through which said current collector is inserted. The seal comprises a peripheral edge and a connecting part connecting said central boss with the peripheral edge. The connecting part has a top surface and a bottom surface. The central boss comprises a top surface and a bottom surface. The top surface of the central boss faces the bottom surface of the end cap and the bottom surface of the central boss does not extend below the bottom surface of the connecting part. The current collector is positioned within the opening of the central boss so that the head of the current collector does not touch the top surface of the central boss thus forming a gap from about 0.01 mm to about 0.50 mm between the head of the current collector and the top surface of the central boss. The head of the current collector is electrically connected to the bottom surface of the end cap.

In another embodiment, the invention is directed towards an electrochemical cell. The electrochemical cell comprises a housing having at least one open end; an anode, a cathode, a separator disposed between the anode and the cathode; and an electrolyte within the housing. An end-cap assembly is fitted within the at least one open end of the housing. The end cap assembly comprises an end cap having a top surface and a bottom surface; a current collector comprising a columnar body with a head at one end thereof; and a seal comprising a central boss with an opening through which said current collector is inserted. The seal comprises a peripheral edge and a connecting part connecting said central boss with the peripheral edge. The connecting part has a top surface and a bottom surface. The central boss comprises a top surface and a bottom surface. The top surface of the central boss faces the bottom surface of the end cap and the bottom surface of the central boss does not extend below the bottom surface of the connecting part. The current collector is positioned within the opening of the central boss so that the head of the current collector does not touch the top surface of the central boss thus forming a gap from about 0.01 mm to about 0.50 mm between the head of the current collector and the top surface of the central boss. The head of the current collector is electrically connected to the bottom surface of the end cap.

### BRIEF DESCRIPTION OF THE DRAWINGS

While the specification concludes with claims particularly pointing out and distinctly claiming the subject matter, which is regarded as forming the present invention, it is believed that the invention will be better understood from the following description taken in conjunction with the accompanying drawings.

FIG. 1 is a cross-section of an electrochemical cell.

FIG. 2 is a view of an end cap assembly of the present invention.

FIG. 3 is a view of a finished electrochemical cell including an end cap assembly of the present invention.

### DETAILED DESCRIPTION OF THE INVENTION

Electrochemical cells, or batteries, may be primary or secondary. Primary batteries are meant to be discharged, e.g., to exhaustion, only once and then discarded. Primary batteries are described, for example, in David Linden, Handbook of Batteries (McGraw-Hill, 4th ed. 2011). Secondary batteries are intended to be recharged. Secondary batteries may be discharged and then recharged many times, e.g., more than fifty times, a hundred times, or more. Secondary batteries are described, e.g., David Linden, Handbook of Batteries (McGraw-Hill, 4th ed. 2011). Accordingly, batteries may include various electrochemical couples and electrolyte combinations. Although the description and examples provided herein are directed towards primary alkaline electrochemical cells, or batteries, it should be appreciated that the invention applies to both primary and secondary batteries of either aqueous or nonaqueous systems. Both primary and secondary batteries of either aqueous or nonaqueous systems are thus within the scope of this application and the invention is not limited to any particular embodiment.

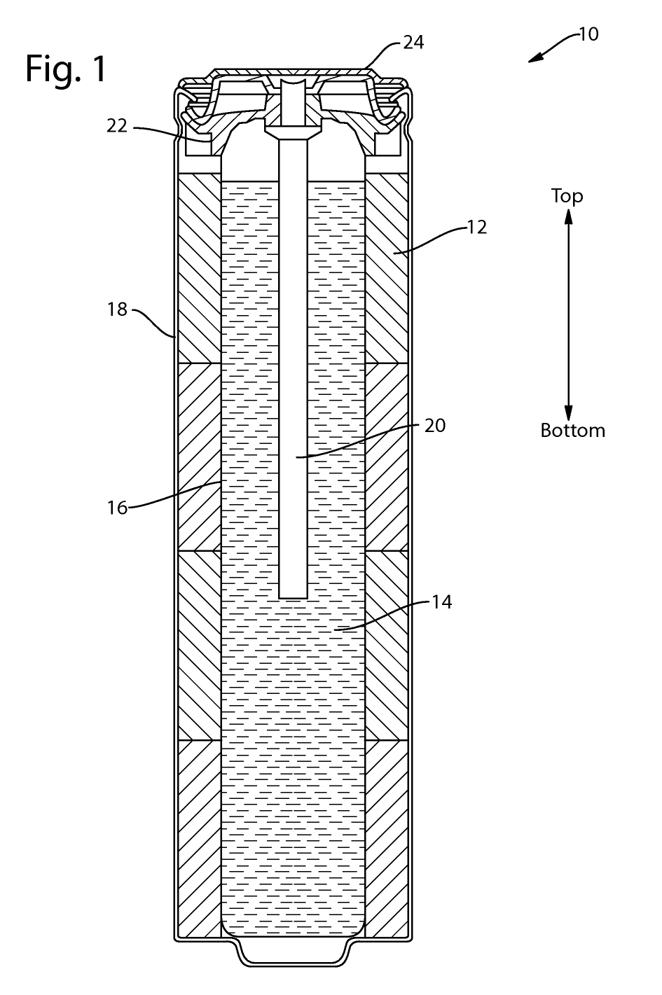

Referring to FIG. 1, an alkaline electrochemical cell, or battery, 10 includes a cathode 12, an anode 14, a separator 16, and a housing 18. Battery 10 also includes current collector 20, seal 22, and an end cap 24. An electrolytic solution (not shown) is dispersed throughout the battery 10. Battery 10 can be, for example, a AA, AAA, AAAA, C, or D alkaline battery.

The housing 18 can be of any conventional type of housing commonly used in primary alkaline batteries and can be made of any suitable material, for example cold-rolled steel or nickel-plated cold-rolled steel. The housing 18 may have a conventional cylindrical shape—or may have any other suitable non-cylindrical shape, e.g., a prismatic shape. The housing 18 may be, for example, deep-drawn from a sheet of the base material, such as cold-rolled steel or nickel-plated steel. The housing 18 may be, for example, drawn into a cylindrical shape. The finished housing 18 may have at least one open end. The finished housing 18 may have a closed end and an open end with a sidewall therebetween. The interior walls of the housing 18 may be treated with a material that has low electrical-contact resistance between the interior wall of the housing 18 and an electrode. The interior walls of the housing 18 may be plated, e.g., with nickel, cobalt, and/or painted with a carbon-loaded paint to decrease contact resistance between the internal wall of the housing and the cathode 12.

Cathode 12 includes one or more electrochemically active cathode materials. The electrochemically active cathode material may include manganese oxide, manganese dioxide, electrolytic manganese dioxide (EMD), chemical manganese dioxide (CMD), high power electrolytic manganese dioxide (HP EMD), lambda manganese dioxide, and mixtures thereof. Other electrochemically active cathode materials include, but are not limited to, silver oxide; nickel oxide; nickel oxyhydroxide; copper oxide; copper salts, such as copper iodate; bismuth oxide; high-valence nickel; oxygen; alloys thereof, and mixtures thereof. The nickel oxide can include nickel oxyhydroxide, cobalt oxyhydroxide-coated nickel oxyhydroxide, delithiated layered lithium nickel oxide, and combinations thereof. The nickel oxyhydroxide can include beta-nickel oxyhydroxide, gamma-nickel oxyhydroxide, and/or intergrowths of beta-nickel oxyhydroxide and/or gamma-nickel oxyhydroxide. The cobalt oxyhydroxide-coated nickel oxyhydroxide can include cobalt oxyhydroxide-coated beta-nickel oxyhydroxide, cobalt oxyhydroxide-coated gamma-nickel oxyhydroxide, and/or cobalt oxyhydroxide-coated intergrowths of beta-nickel oxyhydroxide and gamma-nickel oxyhydroxide. The nickel oxide can include a partially delithiated layered nickel oxide having the general chemical formula Li₁₋ₓH_{y}NiO₂, wherein 0.1≦x≦0.9 and 0.1≦y≦0.9. The high-valence nickel may, for example, include tetravalent nickel.

Electrolytic manganese dioxide (EMD) is a preferred form of manganese dioxide for electrochemical cells, such as alkaline batteries, because of its high density and since it is conveniently obtained at high purity by electrolytic methods. Chemical manganese dioxide (CMD), a chemically synthesized manganese dioxide, has also been used as electrochemically active cathode material in electrochemical cells including alkaline cells and heavy-duty cells.

EMD is typically manufactured from direct electrolysis of an aqueous solution containing manganese sulfate and sulfuric acid. Processes for the manufacture of EMD and its properties appear in Batteries, edited by Karl V. Kordesch, Marcel Dekker, Inc., New York, Vol. 1, (1974), p. 433-488. CMD is typically made by a process known in the art as the “Sedema process,” a chemical process disclosed by U.S. Pat. No. 2,956,860 (Welsh). Battery-grade MnO₂ may be produced via the Sedema process by employing the reaction mixture of MnSO₄ and an alkali metal chlorate, preferably NaClO₃. Distributors of manganese dioxides include Tronox, Erachem, Tosoh, Delta Manganese, and Xiangtan. In batteries where very low or no can distortion during discharge is desired, high power (HP) EMD may be used. Preferably, a battery including HP EMD as a cathode active material has an open circuit voltage (OCV) of at least 1.635 volts (V). A suitable HP EMD is commercially available from Tronox, under the trade name High Drain.

The cathode 12 may also include carbon particles and a binder. The cathode 12 may also include other additives. The cathode 12 will have a porosity that may be calculated, at the time of manufacture, by the following formula:

Cathode Porosity=(1−(cathode solids volume÷cathode volume))×100

The cathode porosity may be from about 15% to about 45% and is preferably between about 22% and about 31%. The porosity of the cathode is typically calculated at the time of manufacturing since the porosity will change over time due to cathode swelling associated with electrolyte wetting of the cathode and battery discharge.

The carbon particles are included in the cathode to allow the electrons to flow through the cathode. The carbon particles may be graphite, such as expanded graphite and natural graphite; graphene, single-walled nanotubes, multi-walled nanotubes, carbon fibers; carbon nanofibers; and mixtures thereof. It is preferred that the amount of carbon particles in the cathode is relatively low, e.g., less than about 7.0%, less than 3.75%, or even less than 3.5%, for example 2.0% to 3.5%. The lower carbon level enables inclusion of a higher loading of active material within the cathode without increasing the volume of the cell or reducing the void volume (which must be maintained at or above a certain level to prevent internal pressure from rising too high as gas is generated within the cell). Suitable expanded graphite for use within a battery can be obtained, for example, from Timcal.

It is generally preferred that the cathode be substantially free of nonexpanded graphite. While nonexpanded graphite particles provide lubricity to the cathode pellet forming equipment, this type of graphite is significantly less conductive than expanded graphite, and thus it is necessary to use more nonexpanded graphite in order to obtain the same cathode conductivity of a cathode containing expanded graphite. While not preferred, the cathode may include low levels of unexpanded graphite, however this will compromise the reduction in graphite concentration that can be obtained while maintaining a particular cathode conductivity.

The cathode components, such as active cathode material(s), carbon particles, binder, and any other additives, may be combined with a liquid, such as an aqueous potassium hydroxide electrolyte, blended, and pressed into pellets for use in the manufacture of a finished battery. For optimal pellet processing, it is generally preferred that the cathode material have a moisture level in the range of about 2.5% to about 5%, more preferably about 2.8% to about 4.6%.

Examples of binders that may be used in the cathode 12 include polyethylene, polyacrylic acid, or a fluorocarbon resin, such as PVDF or PTFE. An example of a polyethylene binder is sold under the trade name COATHYLENE HA-1681 (available from Hoechst or DuPont).

Examples of other cathode additives are described in, for example, U.S. Pat. Nos. 5,698,315, 5,919,598, and 5,997,775 and U.S. application Ser. No. 10/765,569, all hereby incorporated by reference.

The amount of electrochemically active cathode material within the cathode 12 may be referred to as the cathode loading. The loading of the cathode 12 may vary depending upon the electrochemically active cathode material used within, and the cell size of, the battery. For example, AA batteries with a manganese dioxide electrochemically active cathode material may have a cathode loading of at least 9.0 grams of manganese dioxide. The cathode loading may be, for example, at least about 9.5 grams of manganese dioxide. The cathode loading may be, for example, between about 9.7 grams and about 11.5 grams of manganese dioxide. The cathode loading may be from about 9.7 grams and about 11.0 grams of manganese dioxide. The cathode loading may be from about 9.8 grams and about 11.2 grams of manganese dioxide. The cathode loading may be from about 9.9 grams and about 11.5 grams of manganese dioxide. The cathode loading may be from about 10.4 grams and about 11.5 grams of manganese dioxide. For a AAA battery, the cathode loading may be from about 4.0 grams and about 6.0 grams of manganese dioxide. For a AAAA battery, the cathode loading may be from about 2.0 grams and about 3.0 grams of manganese dioxide. For a C battery, the cathode loading may be from about 25.0 grams and about 29.0 grams of manganese dioxide. For a D battery, the cathode loading may be from about 54.0 grams and about 70.0 grams of manganese dioxide.

Anode 14 can be formed of at least one electrochemically active anode material, a gelling agent, and minor amounts of additives, such as organic and/or inorganic gassing inhibitor. The electrochemically active anode material may include zinc; cadmium; iron; metal hydride, such as AB₅(H), AB₂(H), and A₂B₇(H); alloys thereof; and mixtures thereof.

The amount of electrochemically active anode material within the anode 14 may be referred to as the anode loading. The loading of the anode 14 may vary depending upon the electrochemically active anode material used within, and the cell size of, the battery. For example, AA batteries with a zinc electrochemically active anode material may have an anode loading of at least about 3.3 grams of zinc. The anode loading may be, for example, at least about 4.0, about 4.3, about 4.6 grams, about 5.0 grams, or about 5.5 grams of zinc. The anode loading may be between about 4.0 grams and 5.5 grams of zinc. The anode loading may be between about 4.2 grams and 5.2 grams of zinc. AAA batteries, for example, with a zinc electrochemically active anode material may have an anode loading of at least about 1.9 grams of zinc. For example, the anode loading may have at least about 2.0 or about 2.1 grams of zinc. AAAA batteries, for example, with a zinc electrochemically active anode material may have an anode loading of at least about 0.6 grams of zinc. For example, the anode loading may have at least about 0.7 to about 1.0 grams of zinc. C batteries, for example, with a zinc electrochemically active anode material may have an anode loading of at least about 9.5 grams of zinc. For example, the anode loading may have at least about 10.0 to about 15.0 grams of zinc. D batteries, for example, with a zinc electrochemically active anode material may have an anode loading of at least about 19.5 grams of zinc. For example, the anode loading may have at least about 20.0 to about 30.0 grams of zinc.

Examples of a gelling agent that may be used include a polyacrylic acid; a polyacrylic acid cross-linked with polyalkenyl ether of divinyl glycol, such as Carbopol; a grafted starch material; a salt of a polyacrylic acid; a carboxymethylcellulose; a salt of a carboxymethylcellulose (e.g., sodium carboxymethylcellulose); or combinations thereof. The anode may include a gassing inhibitor that may include an inorganic material, such as bismuth, tin, or indium. Alternatively, the gassing inhibitor can include an organic compound, such as a phosphate ester, an ionic surfactant or a nonionic surfactant.

An electrolyte may be dispersed throughout the cathode 12, the anode 14 and the separator 16. The electrolyte comprises an ionically conductive component in an aqueous solution. The ionically conductive component may be a hydroxide. The hydroxide may be, for example, sodium hydroxide, potassium hydroxide, lithium hydroxide, cesium hydroxide, and mixtures thereof. The ionically conductive component may also include a salt. The salt may be, for example, zinc chloride, ammonium chloride, magnesium perchlorate, magnesium bromide, and mixtures thereof. The concentration of the ionically conductive component may be selected depending on the battery design and its desired performance. An aqueous alkaline electrolyte may include a hydroxide, as the ionically conductive component, in a solution with water. The concentration of the hydroxide within the electrolyte may be from about 0.25 to about 0.35, or from about 25% to about 35%, on a total weight basis of the electrolyte. For example, the hydroxide concentration of the electrolyte may be from about 0.25 to about 0.32, or from about 25% to about 32%, on a total weight basis of the electrolyte. The aqueous alkaline electrolyte may also include zinc oxide (ZnO) dissolved within it. The ZnO may serve to suppress zinc corrosion within the anode. The concentration of ZnO included within the electrolyte may be less than about 3% by weight of the electrolyte. The ZnO concentration, for example, may be from about 1% by weight to about 3% by weight of the electrolyte.

The total weight of the aqueous alkaline electrolyte within a AA alkaline battery, for example, may be from about 3.0 grams to about 4.0 grams. The weight of the electrolyte within a AA battery preferably may be, for example, from about 3.3 grams to about 3.8 grams. The weight of the electrolyte within a AA battery may more preferably, for example, from about 3.4 grams to about 3.6 grams. The total weight of the aqueous alkaline electrolyte within a AAA alkaline battery, for example, may be from about 1.0 grams to about 2.0 grams. The weight of the electrolyte within a AAA battery preferably may be, for example, from about 1.2 grams to about 1.8 grams. The weight of the electrolyte within a AA battery may more preferably, for example, from about 1.4 grams to about 1.6 grams.

Separator 16 comprises a material that is wettable or wetted by the electrolyte. A material is said to be wetted by a liquid when the contact angle between the liquid and the surface is less than 90° or when the liquid tends to spread spontaneously across the surface; both conditions normally coexist. Separator 16 may comprise woven or nonwoven paper or fabric. Separator 16 may include a layer of, for example, cellophane combined with a layer of non-woven material. The separator also can include an additional layer of non-woven material. The separator material may be thin. The separator, for example, may have a dry thickness of less than 150 micrometers (microns). The separator, for example, may have a dry thickness of less than 100 microns. The separator preferably has a dry thickness from about 70 microns to about 90 microns, more preferably from about 70 microns to about 75 microns. Separator 16 has a basis weight of 40 g/m² or less. The separator preferably has a basis weight from about, 15 g/m² to about 40 g/m², and more preferably from about 20 g/m² to about 30 g/m². Separator 16 may have an air permeability value. Separator 16 may have an air permeability value as defined in ISO 2965. The air permeability value of Separator 16 may be from about 2000 cm³/cm²·min @ 1 kPa to about 5000 cm³/cm²·min @ 1 kPa. The air permeability value of Separator 16 may be from about 3500 cm³/cm²·min @ 1 kPa to about 3800 cm³/cm²·min @ 1 kPa.

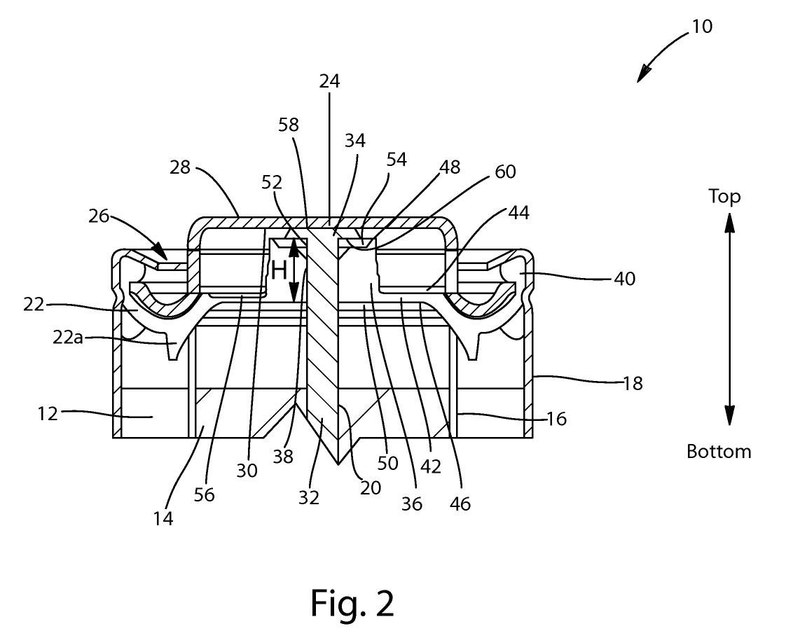

Referring to FIG. 2, an end cap assembly 26 for an alkaline battery 10 includes a current collector 20, a seal 22, and an end cap 24. The end cap assembly 26 may be inserted into an open end of the housing 18 of the battery 10 prior to crimping the battery closed. The end cap assembly 26 helps keep the contents of the battery 10 within the housing 18. The current collector 20 conducts electrons from the anode 14 of the battery 10 through the external circuit of, for example, the device and to the cathode 12. The end cap 24 is electrically connected to the current collector 20 of the battery 10. The seal 22 provides an insulative barrier between the housing 18 and the end cap 24 of the battery 10.

The current collector 20 may be made into any suitable shape for the particular battery design by any known methods within the art. The current collector 20 may have, for example, a nail-like shape. The current collector 20 may have a columnar body 32 and a head 34 located at one end of the columnar body 32. The head 34 of the current collector 20 has a top surface 58 and a bottom surface 60. The current collector 20 may be made of metal, e.g., zinc, copper, brass, silver, or any other suitable material. The current collector 20 may be optionally plated with tin, zinc, bismuth, indium, or another suitable material presenting a low electrical-contact resistance between the current collector 20 and, for example, the anode 14 and an ability to suppress gas formation.

The seal 22 may be prepared by injection molding a polymer, such as polyamide, polypropylene, polyetherurethane, or the like; a polymer composite; and mixtures thereof into a shape with predetermined dimensions. The seal 22 may be made from, for example, Nylon 6,6; Nylon 6,10; Nylon 6,12; polypropylene; polyetherurethane; co-polymers; and composites and mixtures thereof. Exemplary injection molding methods include both the cold runner method and the hot runner method. Seal 22 may contain other known functional materials such as a plasticizer, crystalline nucleating agent, antioxidant, mold release agent, lubricant, and antistatic agent. The seal 22 may also be coated with a sealant. The seal 22 may be moisturized prior to use within the battery 10. The seal 22, for example, may have a moisture content of from about 1.0 weight percent to about 9 weight percent depending upon the seal material.

The seal 22 includes a central cylindrical portion, or boss, 36. The central boss 36 has a top surface 48 and a bottom surface 50. The central boss 36 may have a cylindrical shape. The central boss 36 may have an external diameter. The central boss 36 may have a height, H. The bottom surface 50 of the central boss 36 may include a recess (not shown).

The external diameter of the central boss will depend upon battery size. The diameter of the central boss for AA batteries may be, for example, from at least about 3.40 mm to about 3.70 mm, from at least about 3.50 mm to about 3.60 mm, or about 3.55 mm. The diameter of the central boss for AAA batteries may be, for example, from at least about 2.9 mm to about 3.95 mm, from at least about 2.95 mm to about 3.87 mm, from at least about 3.0 mm to about 3.125 mm. The diameter of the central boss for AAAA batteries may be, for example, from at least about 2.90 mm to about 3.20 mm, from at least about 2.97 mm to about 3.12 mm, or about 3.05 mm. The diameter of the central boss for C and D batteries may be, for example, from at least about 3.40 mm to about 3.70 mm.

The height H of the central boss 36 will depend upon battery size. The height of the central boss for AA batteries may be, for example, from at least about 1.50 mm to about 5.50 mm, from at least about 1.65 mm to about 1.85 mm, from about 2.0 mm to about 2.20 mm, or about 4.90 mm to about 5.25 mm. The height of the central boss for AAA batteries may be, for example, from at least about 2.75 mm to about 4.50 mm, from at least about 2.80 mm to about 3.0 mm, or from at least about 4.20 mm to about 4.45 mm. The height of the central boss for AAAA batteries may be, for example, from at least about 2.25 mm to about 2.60 mm or from at least about 2.35 mm to about 2.55 mm. The height of the central boss for C batteries may be, for example, from at least about 6.15 mm to about 6.65 mm or from about 6.25 mm to about 6.50 mm. The height of the central boss for D batteries may be, for example, from at least about 6.50 mm to about 7.25 mm or from about 6.75 mm to about 7.20 mm.

The central boss 36 may include an opening 38. The current collector 20 may be inserted into and through the opening 38 of the central boss 36. The current collector 20 may be inserted into and through the opening 38 of the central boss 36 so that a gap 52 is present between the bottom surface of the head 34 of the current collector 20 and the top surface 48 of the central boss 36 of the seal 22. The gap 52 may be referred to as the boss-to-nail gap.

The interface of the material surface of the current collector 20 and the material surface of the seal 22 when the current collector 20 is inserted into and through the opening 38 of the central boss 36 will have a static friction coefficient. The static friction coefficient should be such that the current collector 20 does not move during, or after, the housing 18 of the battery 10 is crimped over the end cap assembly. The static friction coefficient may also contribute to the reduction of electrolyte leakage that may occur between the current collector 20 and the central boss 36 of the battery 10. The static friction coefficient should be greater than about 0.095. The static friction coefficient may be, for example from about 0.10 to about 0.50.

The distance of the boss-to-nail gap may be the same for all battery sizes. The boss-to-nail gap may be, for example, from at least about 0.01 mm to about 0.50 mm, from about 0.01 mm to about 0.09 mm, from about 0.10 mm to about 0.40 mm, or from about 0.20 mm to about 0.30 mm, or about 0.225 mm to about 0.275 mm.

A sealant (not shown) may be placed on the top surface of the boss and/or on the nail prior to inserting the current collector 20 into and through the opening 38 of the central boss 36 to reduce the possibility of electrolyte leakage between the current collector 20 and the opening 38 of the central boss 36. The top surface 48 of the central boss 36 may include a recess 54. A sealant (not shown) may be placed within the recess 54 prior to inserting the current collector 20 into and through the opening 38 of the central boss 36 to reduce the possibility of electrolyte leakage between the current collector 20 and the opening 38 of the central boss 36. The sealant that may be placed within the gap prior to inserting the current collector into and through the opening 38 of the central boss 36 and the sealant that may be placed within the recess 54 prior to inserting the current collector into and through the opening 38 of the central boss 36 may be any sealant that exhibits a resistance to chemical degradation in the presence of electrolyte. The sealant may completely or partially fill the gap 52 and/or the recess 54. The sealant may be, for example, a polyamide, a resin, a solution of polyvinyl alcohol in water, blown asphalt, polybutene, polyisobutylene, polyethylene wax, and mixtures thereof.

The seal 22 includes a peripheral edge 40. The peripheral edge 40 is interposed between the end cap 24 and the housing 18 of the battery 10. The seal 22 includes a connecting part 42 that connects the central boss 36 to the peripheral edge 40. The connecting part 42 has a top surface 44 and a bottom surface 46. The bottom surface of the central boss 50 does not extend past, beyond, or below the bottom surface 46 of the connecting part 42.

The connecting part 42 may include a rupturable vent 56 that is integral to the connecting part 42. The rupturable vent 56 may be located on the top surface 44 of the connecting part 42, may be located on the bottom surface 46 of the connecting part 42, and may be located on both the top surface 44 and bottom surface 46 of the connecting part 42. The rupturable vent 56 may be a thinned section of the connecting part 42 that acts as a safety release should the gas pressure internal to the battery housing become excessively high due to, for example, a short-circuit condition. The rupturable vent 56 may be of any shape and configuration. The rupturable vent 56 may, for example, have a circular shape, an oval shape, a v-channel shape, a polygonal shape, and combinations thereof. The rupturable vent 56 may, for example, have an annular configuration, a radial configuration, a coined configuration, and combinations thereof.

The thickness of the rupturable vent will vary depending upon battery size. For example, the thickness of a rupturable vent for AA batteries may be from about 0.02 mm to about 0.20 mm. For example, the thickness of a rupturable vent for AAA batteries may be from about 0.05 mm to about 0.20 mm. The thickness of the rupturable vent may be, for example, from about 0.06 mm to about 0.095 mm or from about 0.15 mm to about 0.18 mm. For example, the thickness of a rupturable vent for AAAA batteries may be from about 0.07 mm to about 0.10 mm. For example, the thickness of a rupturable vent for C batteries may be from about 0.08 mm to about 0.20 mm. For example, the thickness of a rupturable vent for D batteries may be from about 0.038 mm to about 0.155 mm.

The seal 22 may also include other structural features. The seal 22 may, for example, include a skirt 22a. The skirt may function to hold separator material in place when the open end of the battery is crimped closed over the end cap assembly. The seal 22 may also include features (not shown) that absorb and/or cushion deformation that may occur during cell assembly, such as during crimping. These features may, for example, limit undesirable transfer of deformation of and transfer of stress to, the rupturable vent 56 within the seal 22.

The end cap 24 may function as the negative terminal of battery 10. The end cap 24 may be formed in any shape sufficient to close the respective battery. The end cap 24 may have, for example, a cylindrical or prismatic shape. The end cap 24 may be formed by pressing a material into the desired shape with suitable dimensions. The end cap 24 may be made from any suitable material that will conduct electrons during the discharge of the battery 10. The end cap 24 may be made from, for example, nickel-plated steel or tin-plated steel. The end cap 24 may have a top surface 28 and a bottom surface 30. The end cap 24 may be electrically connected to the current collector 20. The bottom surface 30 of the end cap 24 may be electrically connected to the top surface 58 of the head 34 of the current collector 20. The bottom surface 30 of the end cap 24 may, for example, make electrical connection to the head 34 of the current collector 20 by being in physical contact with the top surface 58 of the head 34 of the current collector 20. The bottom surface 30 of the end cap 24 may, for example, make electrical connection to the head 34 of the current collector 20 by being welded to the top surface 58 of the head 34 of the current collector 20. The end cap 24 may also include one or more apertures (not shown), such as holes, for venting any gas pressure that may build up under the end cap 24 during a gassing event within the battery 10, for example, during deep discharge or reversal of a battery within a device, that leads to rupture of vent 56.

It has been found that certain designs of the seal may be susceptible to cracking or detaching between the connecting part and the central boss. Batteries exhibiting a cracked or detached boss have a higher tendency to leak when compared to batteries that do not exhibit this condition. The detached or cracked boss may be caused, for example, when internal stress exceeds the ultimate stress of the seal material. In addition, stress at the external diameter of the central boss that exceeds the yield stress of the seal material may also contribute to cracking of the boss. For example, the stress at the external diameter of the central boss should be less than the yield point of the material selected for the seal. Additional stresses after crimping may also cause or further exacerbate the tendency for the seal to structurally fail and for the battery to subsequently leak. In addition, environmental conditions, such as high ambient temperatures and high relative humidity, that battery may be exposed to, for example, during storage or shipment, may also exacerbate structural failure of the seal and result in increased leakage. The end cap assembly of the present invention includes a seal where the bottom surface of the central boss does not extend below the bottom surface of the connecting part of the seal. The end cap assembly of the present invention also includes a current collector inserted into and through the opening of the central boss such that a gap is present between the bottom surface of the head of the current collector and the top surface of the central boss of the seal. These features, inter alia, help minimize the stress exerted at the connection point between the central boss and the connecting part of the seal. These features, when the end cap assembly is incorporated within a battery, also help mitigate structural failure of the seal attributable to the exposure of the battery to environmental conditions, such as high temperature and high relative humidity.

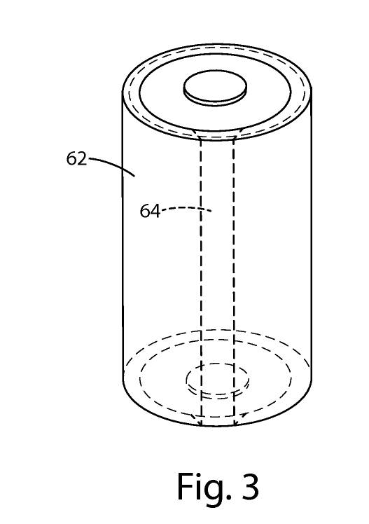

Referring to FIG. 3, a battery 10 is shown including a label 62 that has an indicator, or tester, 64 incorporated within it to determine the voltage, capacity, state, and/or power of the battery 10. The label 62 may be a laminated multi-layer film with a transparent or translucent layer bearing the label graphics and text. The label 62 may be made from polyvinyl chloride (PVC), polyethylene terephthalate (PET), and other similar polymer materials. Known types of testers that are placed on batteries may include thermochromic and electrochromic indicators. In a thermochromic battery tester the indicator may be placed between the anode and cathode electrodes of the battery. The consumer activates the indicator by manually depressing a switch. Once the switch is depressed, the consumer has connected an anode of the battery to a cathode of the battery through the thermochromic tester. The thermochromic tester may include a silver conductor that has a variable width so that the resistance of the conductor also varies along its length. The current generates heat that changes the color of a thermochromic ink display that is over the silver conductor as the current travels through the silver conductor. The thermochromic ink display may be arranged as a gauge to indicate the relative capacity of the battery. The higher the current the more heat is generated and the more the gauge will change to indicate that the battery is good.

### Experimental Testing

### Performance Testing of Assembled AA Alkaline Primary Batteries

An exemplary AA battery is assembled to evaluate the effects of the present invention on battery leakage and discharge performance. The anode includes an anode slurry containing 4.26 grams of zinc; 1.797 grams of a potassium hydroxide alkaline electrolyte with about 31% KOH by weight and 2% by ZnO dissolved in water; 0.0265 grams of polyacrylic acid gellant; and 0.005 grams of corrosion inhibitor. The cathode includes a blend of EMD, graphite, and potassium hydroxide aqueous electrolyte solution. The cathode includes a loading of 9.987 grams of EMD, a loading of 0.1163 grams of Timcal BNB-90 graphite, 0.464 grams of Timcal MX15 graphite, and 0.632 grams of electrolyte. A separator is interposed between the anode and cathode. The anode, cathode, separator, and an additional 1.330 grams of electrolyte are placed in an open end of a housing that is cylindrical in shape. An end cap assembly is provided including a seal of varying design. A current collector is inserted into and through an opening of a central boss of the seal so that a boss-to-nail gap is varied. The end cap assembly is placed into the open end of the housing. The housing is then crimped over the end cap assembly to finish off the battery assembly process.

Batteries that undergo discharge performance testing may first be exposed to a temperature conditioning regime. Under the temperature conditioning regime, battery is exposed to varying temperature over the course of 14 days. The battery is exposed to what may be referred to as one cycle over the course of a single 24 hour period. A cycle consists of exposing the battery to temperatures that are ramped down from about 28° C. to about 25° C. over the course of six and one half (6.5) hours. The battery is then exposed to temperatures that are ramped up from about 25° C. to about 34° C. over the course of four and one half (4.5) hours. The battery is then exposed to temperatures that are ramped up from about 34° C. to about 43° C. over the course of two (2) hours. The battery is then exposed to temperatures that are ramped up from about 43° C. to about 48° C. over the course of one (1) hour. The battery is then exposed to temperatures that are ramped up from about 48° C. to about 55° C. over the course of one (1) hour. The battery is then exposed to temperatures that are ramped down from about 55° C. to about 48° C. over the course of one (1) hour. The battery is then exposed to temperatures that are ramped down from about 48° C. to about 43° C. over the course of one (1) hour. The battery is then exposed to temperatures that are ramped down from about 43° C. to about 32° C. over the course of three (3) hours. The battery is finally exposed to temperatures that are ramped down from about 32° C. to about 28° C. over the course of four (4) hours. The cycle is repeated over the course of 14 days and then the battery undergoes discharge performance testing.

Performance testing includes discharge performance testing that may be referred to as the ANSI/IEC Motorized Toys Test (Toy Test). The Toy Test protocol includes applying a constant load of 3.9 Ohms for 1 hour to a battery after the battery is exposed to the temperature conditioning regime above. The battery then rests for a period of 23 hours. This cycle is repeated until the cutoff voltage of 0.8 volts is reached. The service hours achieved is then reported.

Performance testing also includes discharge performance testing that may be referred to as the ANSI/IEC Remote Controls Test (Remote Controls Test). The Remote Controls Test protocol includes applying a constant load of 24 Ohms for 15 seconds per minute for 8 hours to a battery. The battery then rests for a period of 16 hours. This cycle is repeated until the cutoff voltage of 1.0 volts is reached. The service hours achieved is then reported.

Performance testing also includes discharge performance testing that may be referred to as the ANSI/IEC Clock/Radio Test (Clock/Radio Test). The Clock/Radio Test protocol includes applying a constant load of 43 Ohms for 4 hours to a battery. The battery then rests for a period of 20 hours. This cycle is repeated until the cutoff voltage of 0.9 volts is reached. The service hours achieved is then reported.

Performance testing also includes discharge performance testing that may be referred to as the ANSI/IEC CD Player & Electronic Game Test (CD Player Test). The CD Player Test protocol includes applying a constant load of 0.25 Amps for 1 hour to a battery after the battery is exposed to the temperature conditioning regime above. The battery then rests for a period of 23 hours. This cycle is repeated until the cutoff voltage of 0.9 volts is reached. The service hours achieved is then reported.

Performance testing also includes discharge performance testing that may be referred to as the ANSI/IEC Audio Test (Audio Test). The Audio Test protocol includes applying a constant load of 0.100 Amps for 1 hour to a battery. The battery then rests for a period of 23 hours. This cycle is repeated until the cutoff voltage of 0.9 volts is reached. The service hours achieved is then reported.

Performance testing also includes discharge performance testing that may be referred to as the ANSI/IEC Toothbrush and Shaver Test (Toothbrush Test). The Toothbrush Test protocol includes applying a constant load of 0.5 Amps for 2 minutes to a battery after the battery is exposed to the temperature conditioning regime above. The battery then rests for a period of 15 minutes. This cycle is repeated until the cutoff voltage of 0.9 volts is reached. The service hours achieved is then reported.

Performance testing also includes accelerated storage testing that may be referred to as the Temperature-Humidity Test (THT). THT testing includes exposing an assembled battery to an elevated temperature at elevated relative humidity over the course of 29 days. The battery is first exposed to a pretest step of one day at ambient conditions, e.g. about 21° C. and about 50% relative humidity. The battery is then exposed to a weekly cycle. The weekly cycle includes exposure to elevated temperature at elevated relative humidity followed by a rest period at ambient conditions. During the weekly cycle, the battery is exposed for six days to a temperature of 60° C. at 90% relative humidity and then allowed to rest under ambient conditions for a period of 16 to 24 hours. The weekly cycle is completed a total of four times. The percentage of leakage is then reported.

Performance testing also includes accelerated storage testing after partial discharge of an assembled battery that may be referred to as the Partial Discharge Temperature-Humidity Storage Test (PD-THT). PD-THT testing includes partially discharging an assembled battery followed by exposing the partially discharged battery to a THT cycle over the course of 29 days. A AA battery, for example, is discharged at a constant resistance of 3.9 Ohms for a period of one and one half (1.5) hours. A AAA battery, for example, is discharged at a constant resistance of 10 Ohms for a period of two (2) hours. The THT cycle is as described in the Temperature-Humidity Test above. The percentage of leakage is then reported.

Performance testing also includes accelerated storage testing after partial discharge of an assembled battery that may be referred to as the Partial Discharge 71° C. Storage Test (PD-71° C.). PD-71° C. testing includes partially discharging an assembled battery followed by exposing the partially discharged battery to a 71° C. storage over the course of 29 days. A AA battery, for example, is discharged at a constant resistance of 3.9 Ohms for a period of one and one half (1.5) hours. The partially discharged battery is then exposed to an elevated temperature over the course of 29 days. The battery is first exposed to a pre-conditioning step of one day at ambient conditions, e.g. about 21° C. and about 50% relative humidity. The battery is then exposed to a weekly cycle. The weekly cycle includes exposure to elevated temperature followed by a rest period at ambient conditions. During the weekly cycle, the battery is exposed for six days to a temperature of 71° C. and then allowed to rest under ambient conditions for a period of 16 to 24 hours. The weekly cycle is completed a total of four times. The percentage of leakage is then reported.

### Performance Testing Results

A size AA battery is assembled with an end cap assembly that includes a seal with a central boss that does not extend past a bottom surface of a connecting part and with a boss-to-nail gap of 0.27 mm. The battery is stored at room temperature, e.g., at about 21° C., and then the following tests are performed: Toy Test, Remote Controls Test, Clock/Radio Test, CD Player Test, Toothbrush Test, Audio Test, THT, PD-THT, and PD-71° C.

The battery exhibits an average performance of 8.52 service hours on the Toy Test; an average of 50.71 service hours on the Remote Controls Test; an average of 97.60 service hours on the Clock/Radio Test; an average of 9.09 service hours on the CD Player Test; an average of 3.86 service hours on the Toothbrush Test; and an average of 26.47 service hours on the Audio Test. The battery exhibits statistically equal performance on the Toy Test, Remote Controls Test, Clock/Radio Test, CD Player Test, Toothbrush Test, and Audio Test versus a comparative battery with an end cap assembly that includes the combination of a seal with a central boss that extends past a bottom surface of a connecting part and without a boss to nail gap [i.e., a boss-to-nail gap of zero (0) mm]. The battery also exhibits 0% THT leakage; 32% PD-THT leakage; and 0% PD-71° C. leakage versus, respectively, 2%, 40%, and 64% leakage for the comparative battery.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An end cap assembly for an electrochemical cell comprising:
an end cap having a top surface and a bottom surface;
a current collector comprising a columnar body with a head at one end thereof;
a seal comprising a central boss with an opening through which said current collector is inserted, a peripheral edge, and a connecting part connecting said central boss with said peripheral edge, said connecting part having a top surface and a bottom surface;
said central boss comprising a top surface and a bottom surface, said top surface of said central boss facing said bottom surface of said end cap and said bottom surface of said central boss does not extend below said bottom surface of said connecting part;
said current collector being positioned within said opening of said central boss so that said head of said current collector does not touch said top surface of said central boss thus forming a gap from about 0.01 mm to about 0.50 mm between said head of said current collector and said top surface of said central boss; and
said head of said current collector is electrically connected to said bottom surface of said end cap.

2. The end cap assembly for an electrochemical cell of claim 1 further comprising a sealant in said gap between said head of said current collector and said top surface of said central boss.

3. The end cap assembly for an electrochemical cell of claim 1 wherein said top surface of said central boss has a recess.

4. The end cap assembly for an electrochemical cell of claim 3 further comprising a sealant in said recess in said top surface of said central boss.

5. The end cap assembly for an electrochemical cell of claim 1 wherein said seal comprises a material selected from the group consisting of a polymer, a polymer composite, and mixtures thereof.

6. The end cap assembly for an electrochemical cell of claim 5 wherein said material is selected from the group consisting of Nylon 6,6, Nylon 6,10, Nylon 6,12, polyamide, polypropylene, polyetherurethane, and mixtures thereof.

7. The end cap assembly for an electrochemical cell of claim 1 wherein said seal comprises a rupturable vent integral to said connecting part.

8. An electrochemical cell comprising:
a housing having at least one open end;
an anode, a cathode, a separator disposed between said anode and said cathode, and an electrolyte within said housing;
an end-cap assembly fitted within said at least one open end of said housing, said end-cap assembly comprising a current collector, an end cap; and a seal;
said end cap having a top surface and a bottom surface;
said current collector comprising a columnar body with a head at one end thereof;
said seal comprising a central boss with an opening through which said current collector is inserted, a peripheral edge, and a connecting part connecting said central boss with said peripheral edge, said connecting part having a top surface and a bottom surface;
said central boss comprising a top surface and a bottom surface, said top surface of said central boss facing said bottom surface of said end cap and said bottom surface of said central boss does not extend below said bottom surface of said connecting part;
said current collector positioned within said opening of said central boss so that said head of said current collector does not touch said top surface of said central boss thus forming a gap from about 0.01 mm to about 0.50 mm between said head of said current collector and said top surface of said central boss; and
said head of said current collector is electrically connected to said bottom surface of said end cap.

9. The electrochemical cell of claim 8 wherein said electrochemical cell comprises a size selected from the group consisting of AAAA, AAA, AA, C, and D.

10. The electrochemical cell of claim 8 comprising a sealant in said gap between said head of said current collector and said top surface of said central boss.

11. The electrochemical cell of claim 8 wherein said top surface of said central boss has a recess.

12. The electrochemical cell of claim 11 comprising a sealant in said recess in said top surface of said central boss.

13. The electrochemical cell of claim 8 wherein said seal comprises a material selected from the group consisting of a polymer, a polymer composite, and mixtures thereof.

14. The electrochemical cell of claim 8 wherein said material is selected from the group consisting of Nylon 6,6, Nylon 6,10, Nylon 6,12, polyamide, polypropylene, polyetherurethane, and mixtures thereof.

15. The electrochemical cell of claim 8 wherein said seal comprises a rupturable vent integral to said connecting part.

16. The electrochemical cell of claim 8 further comprising a label affixed to an outer surface of the housing wherein the label includes a tester.
